(19) United States
(12) Patent Application Publication
(10) Pub. No.: US 2007/0221072 A1
(43) Pub. Date: Sep. 27, 2007

(54) SYSTEMS AND METHODS FOR AUTOMATICALLY TRIMMING AND CORING ROMAINE LETTUCE AND OTHER HARVESTED PRODUCTS

(75) Inventors: Peter de Groot, Carmel, CA (US); Brian Caprara, Salinas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Dennis Caprara, Gonzales, CA (US)

(21) Appl. No.: 11/617,241

(22) Filed: Dec. 28, 2006

Related U.S. Application Data
(60) Provisional application No. 60/785,733, filed on Mar. 23, 2006.

(51) Int. Cl. A23N 4/04

(52) U.S. Cl. 99/537

(57) ABSTRACT

A conveyor system includes a plurality of produce clamps that rotate around a clamp conveyor assembly. On a field side of the conveyor system, a synchronous conveyor belt provides a support for the butt or stem of a plant placed thereon, in between clamps. As the clamp conveyor turns away from the field side, the clamps close and fully support the plants. The conveyor assembly carries the clamps, and the clamped plants, through a series of coring and trimming blades. The clamps then open to release the cored and trimmed product onto a collection conveyor, and the clamps continue to the field side to receive further plants for processing.

### CROSS-REFERENCES TO RELATED APPLICATIONS

This application claims the benefit of U.S. Provisional Application No. 60/785,733 (Attorney docket No. 026129-000210US), filed Mar. 23, 2006, the disclosure of which is incorporated herein by reference in its entirety.

### BACKGROUND OF THE INVENTION

The present invention relates generally to systems and methods for trimming and coring harvested products, and more particularly to systems and methods for automatically trimming and coring Romaine lettuce and other head (leaf) lettuce varieties.

A large percentage of the Romaine lettuce that is grown is harvested for use in precut bagged salads. The producers of these salads have found that the upper part of the outside leaves and the “core” of the Romaine lettuce are undesirable parts of the plant and must be trimmed away and never included in the finished bag of salad.

When bagged salads first became popular, whole heads of Romaine lettuce were harvested and transported from the fields to the processing plants. In those plants a large labor force was employed to remove the undesirable plant parts and the remaining good parts of each head were placed on a separate conveyor belt bringing that product to the slicing machinery. The cull material was collected and subsequently trucked away, often to composting enterprises.

As the salad industries progressed, it was found to be desirable to do much of this trimming in the field at the time of harvest. This reduced the labor force required in the processing plants and eliminated the trucking expense of hauling the cull material. It could be argued that to a certain extent, the overall handling of the product was reduced.

A typical current field trimming process typically works as follows. A cutter person works together with a trimmer person. The cutter, employing a straight knife, selects an appropriate Romaine head in the field, and severs it at an optimum distance from the ground. He then places the cut head on a “setup tray” or some other temporary shelf like device. Typically the trimmer person will then pick up the head, and using a trimming knife (and often employing a cutting board), trim the upper outer leaves and then cut out the core with a “V” cut. The trimmer person places the remaining part of the Romaine head onto a collection conveyor or into a field tote. The trimmed product is collected and transported to the processing plant ready to be sliced into salads with no further trimming by personnel at the processing plant.

It would, however, be desirable to provide systems and methods that further reduce handling of the product and further reduce expenses.

### SUMMARY OF THE INVENTION

The present invention provides systems and methods for automatically trimming and coring harvested products, such as Romaine lettuce, and other head (leaf) lettuce varieties and leafy vegetables.

According to aspects of the present invention, a conveyor system is provided that includes a plurality of produce clamps that rotate around a clamp conveyor assembly. On a field side of the conveyor system, a synchronous conveyor belt provides a rest for the butt or stem of a plant placed thereon, in between clamp arms. As the clamp conveyor turns away from the field side, the clamps close and fully support the plants. The conveyor assembly carries the clamps, and the clamped plants, through a series of coring and trimming blades. The clamps then open to release the cored and trimmed product onto a collection conveyor, and the clamps continue to the field side to receive further plants for processing. The present invention effectively eliminates the “trimmers” as described above that are needed in current field cutting and trimming operations and thereby reduces the manual handling and associated costs.

According to one aspect, a lettuce trimming apparatus is provided that typically includes a plurality of receiver clamps coupled to a rotating conveyor system, each clamp configured to hold a head of lettuce, and a plurality of blades positioned in a path of the receiver clamps and configured to trim and core a lettuce head clamped in a passing receiver clamp. In certain aspects, the clamps are configured in an open state along a first portion of the conveyor system and in a closed state along a second portion of the conveyor system.

According to another aspect, a method is provided for automatically trimming and coring a produce head. The method typically includes automatically clamping a severed produce head in known orientation in one of a plurality of clamp assemblies moving around a clamp assembly conveyor system, and transporting the clamped produce head through a cutting system comprising two or more cutting blades configured to trim and remove a core of the oriented produce head, wherein the clamped head is trimmed and cored by the cutting system. The method also typically includes automatically releasing the trimmed and cored produce head proximal to a collection conveyor.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates a perspective view of a trimming apparatus according to one embodiment.

FIG. 2 illustrates a different perspective view of the apparatus of FIG. 1.

FIG. 3 illustrates a perspective view of a carrier assembly including a pair of open clamp arms according to one embodiment.

FIGS. 4a-4b illustrate different perspective views of the carrier assembly of FIG. 3 including a clamping mechanism; FIGS. 4c-4d illustrate different perspective views of the elements and operation of a clamping mechanism.

FIG. 5 illustrates an end view (looking down the path of travel of a clamped Romain head) of a blade tunnel including coring and trimming blades according to one embodiment.

FIG. 6 illustrates a perspective view of the coring blades of the blade tunnel of FIG. 5.

FIG. 7 illustrates a perspective view of the trimming blades of the blade tunnel of FIG. 5.

FIGS. 8-10 illustrate views of an embodiment including synchronized side conveyors.

### DESCRIPTION OF THE INVENTION

The present invention provides systems and methods for automatically trimming and coring harvested products, such as Romaine lettuce, and other head (leaf) lettuce varieties and leafy vegetables.

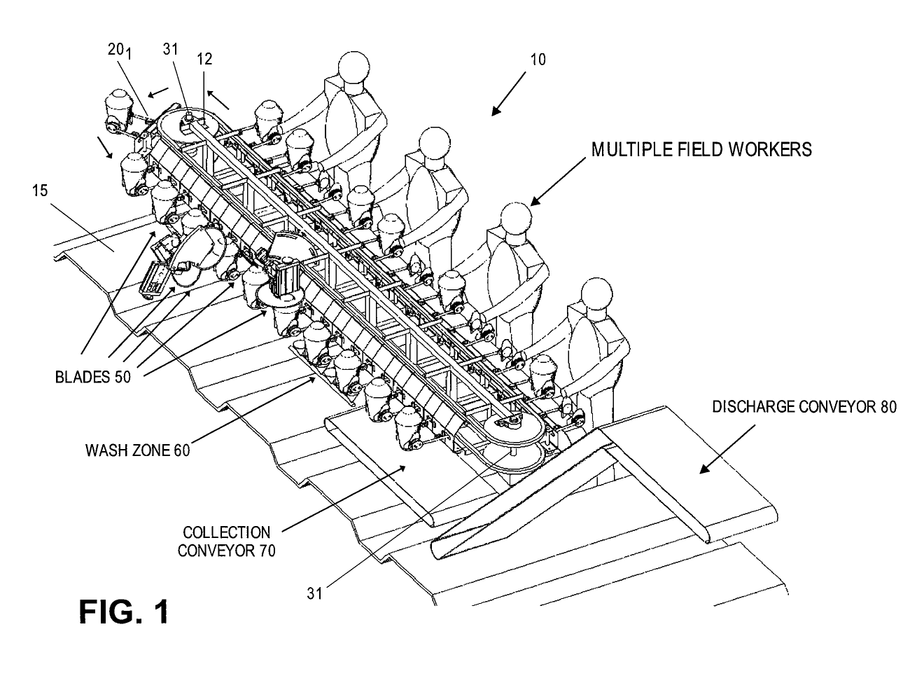

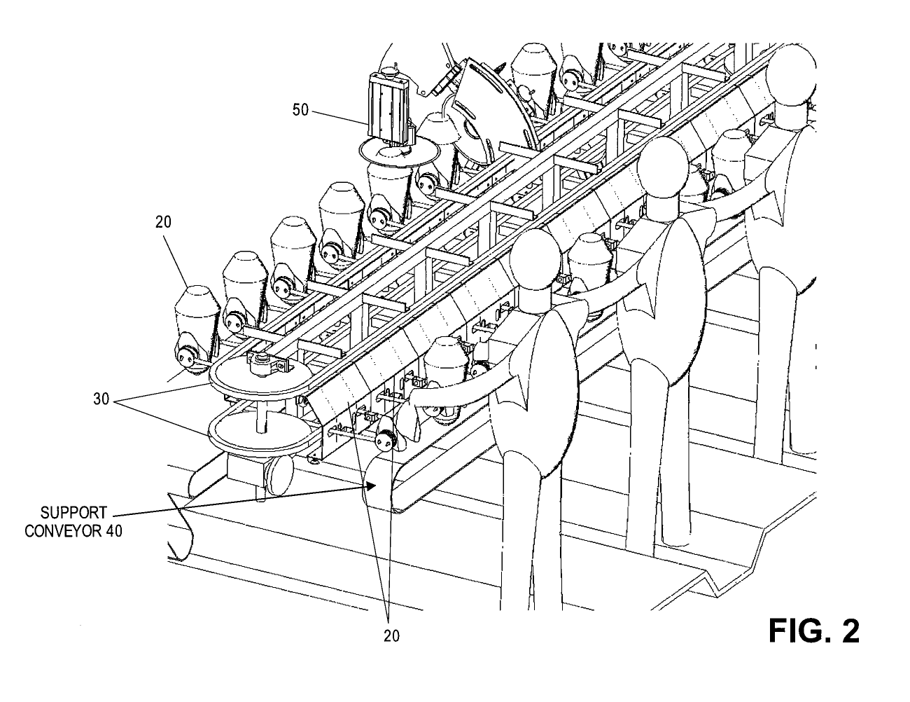

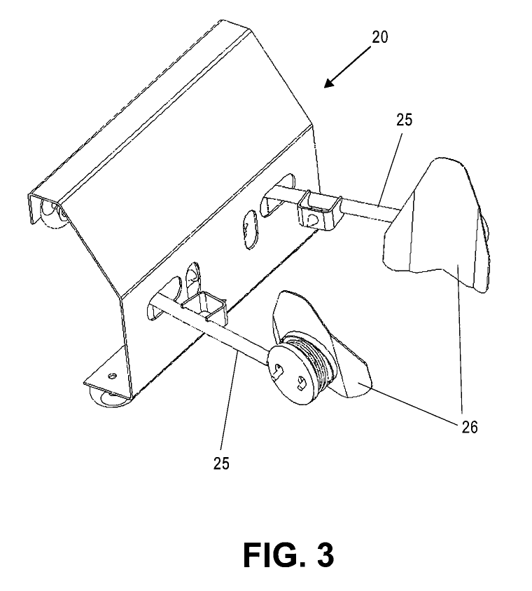

FIGS. 1-7 illustrate various system and operational views of a trimming apparatus 10 and various components according to one embodiment. FIGS. 1 and 2 illustrate different perspectives of an apparatus 10 according to one embodiment. A chassis 12 is provided to hold various device components. As shown, device components include a clamp conveyor assembly 30 having a plurality of clamp assemblies 20, a synchronized support conveyor system 40 and a plurality of blades 50 configured to remove the core and/or trim a produce head 18 held by a clamp assembly 20. Chassis 12 in one aspect includes wheels (not shown) so that apparatus 10 may travel along a soil bed 15 as workers pick and place produce heads 18 (e.g., Romaine and head lettuce). Apparatus 10 may be self-propelled, e.g., include an engine, gears and a steering mechanism, or it may be propelled by another device, such as a tractor. For example, chassis 12 may be configured to attach to a tractor so that a tractor may push (or pull) the apparatus along soil bed 15. The entire trimming apparatus can also be fixed or stationary, e.g., for use inside a production facility.

As shown, the cutters (field workers) are responsible for selecting an appropriate head of Romaine and severing it at an optimum distance above the ground, typically with a straight cut parallel to ground. The cutter then places the severed head proximal to one of a plurality of clamp assemblies 20 on moving receiver clamp conveyor system 30 as shown in FIG. 2. In one aspect, the receiver clamp assemblies 20 each include a pair of opposing clamp arms 25 coupled with gripper elements 26 (“clamps”). When viewed from above, for example, the plurality of clamp assemblies 30 form a conveyor shaped like an elliptical racetrack. Clamp conveyor assembly 30, in one aspect, includes a chain or belt driven by a pair of rotation members or chain drive sprockets 31, one or both of which are coupled to a drive mechanism for operating the conveyor assembly 30 in a chain-driven fashion. A plurality of clamp assemblies 20 are coupled to the chain or belt as shown. To facilitate receiving a severed lettuce head, the clamps are in an open position when facing the field cutters. A biasing mechanism, as will be described in more detail below, provides a biasing force for opening and/or closing clamp arms at appropriate positions along conveyor system 30. FIG. 3 shows a carrier assembly 20 including clamp arms 25 in an open position. Each clamp arm 25 includes or is coupled with a gripper element 26. In one aspect, a gripper element 26 is flexibly attached to an arm 25 to allow for element 26 to adapt to the shape of a head when the arm closes. Gripper element 26 in one aspect, is formed of, or is coated with, a silicon material (e.g., Si or a Si gel) or other bio-compatible material so as to prevent water penetration into the gripper element. In one aspect, the gripper material includes FDA approved Urethane or other plastic material.

In one aspect, to facilitate receiving a Romaine head between open clamp arms, synchronized support conveyor 40 is included to provide a surface upon which a head may rest when placed by a cutter person. In one aspect, the butt or stem of the plant registers onto an indexed receiver location or pocket moving on a synchronized support belt 40. The location or pocket supports the head within the clamp arms 25. Each receiver location or pocket may include a cup-shaped element, for example, protrusions on the support belt that define cup-shaped receiver locations. The support belt 40 (including receiver locations) rotates synchronously with the conveyor system 30 so that each clamp assembly (and also clamp arms) aligns with a receiver location. In another aspect, a synchronous conveyor system 40 without indexed or dedicated receiver locations or pockets may be used, e.g., a flat belt that provides a continuous flat surface upon which the butt or stem may rest.

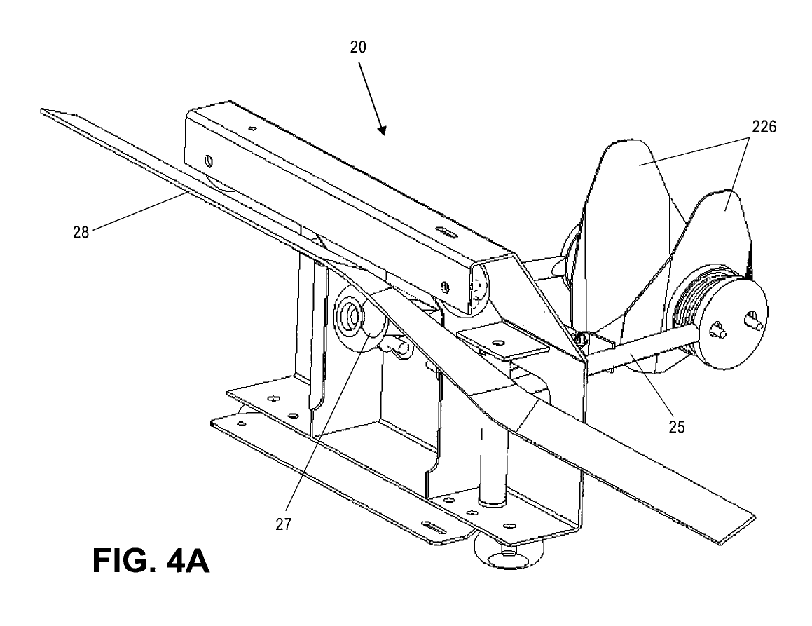

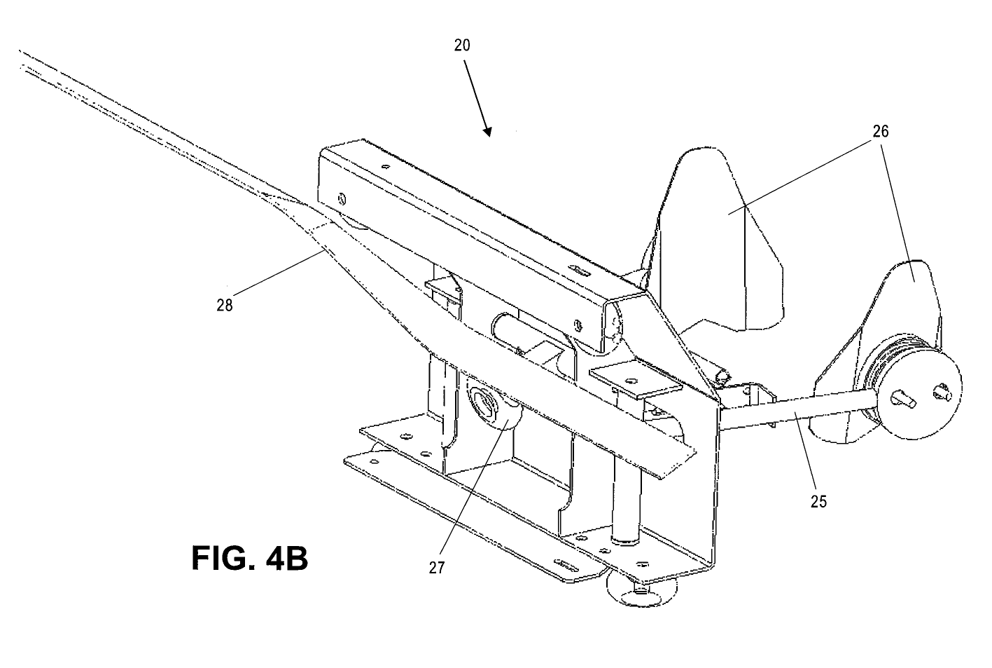

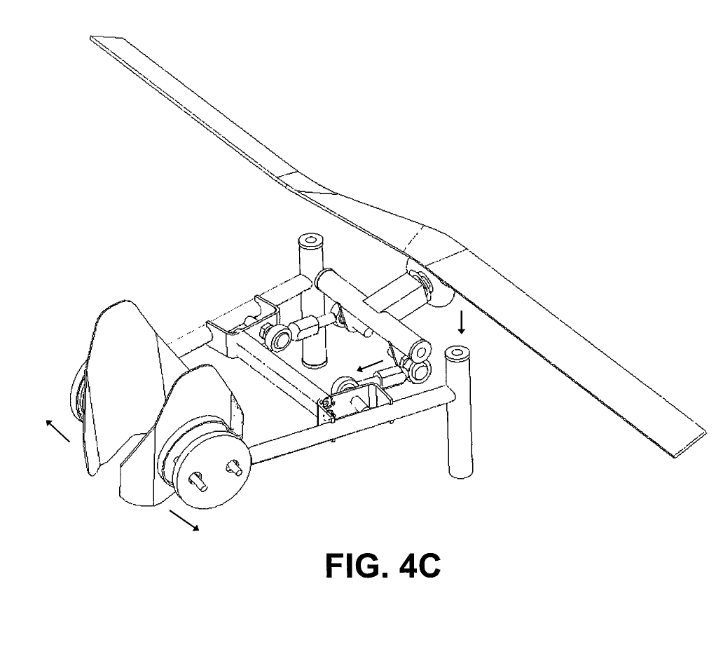

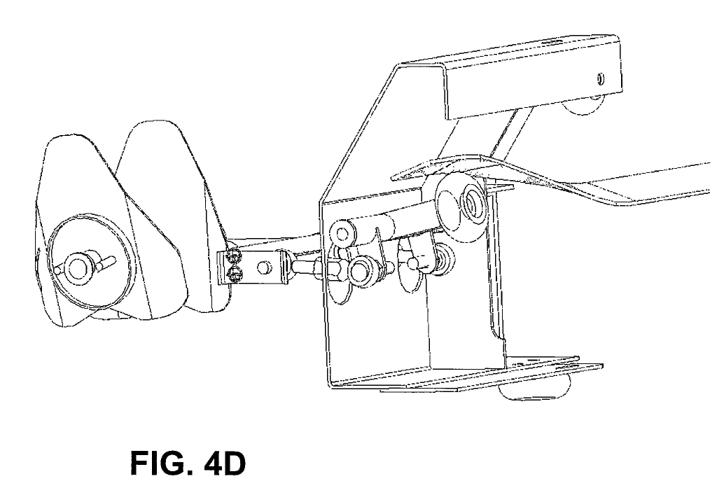

Just prior to starting the conveyor turn as shown, e.g., at the top of FIG. 1, the clamps of an assembly 20 fully close around the Romaine head 18, and the support conveyor turns away. The synchronized support belt 40 also turns away, e.g., downward, at that point. At that point, the Romaine head 18 is fully supported by the clamps as shown in assembly 201, e.g., in FIG. 4. For example, at the end of the field side of the conveyor, the clamp biasing mechanism is activated (or deactivated), allowing the clamp arms to close around the Romaine head 18, thus fully supporting the head.

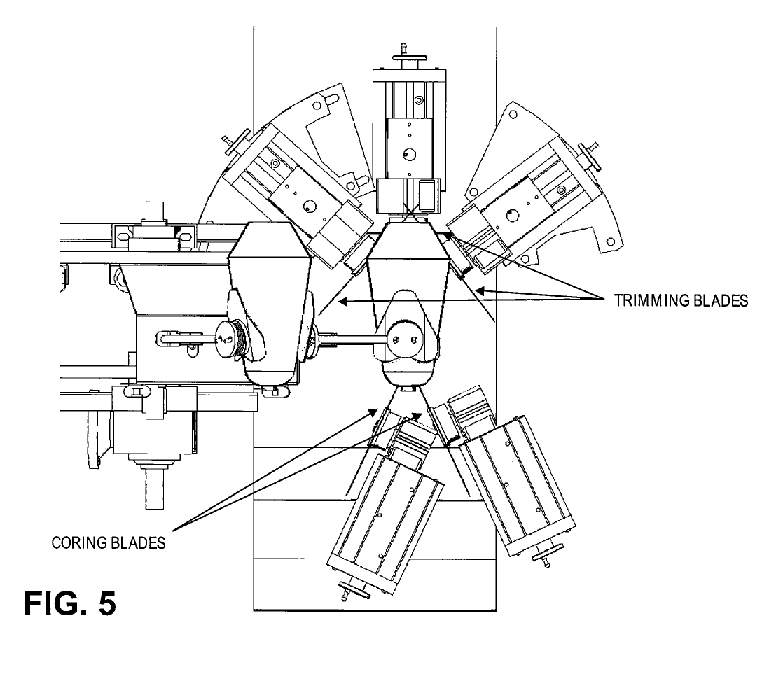

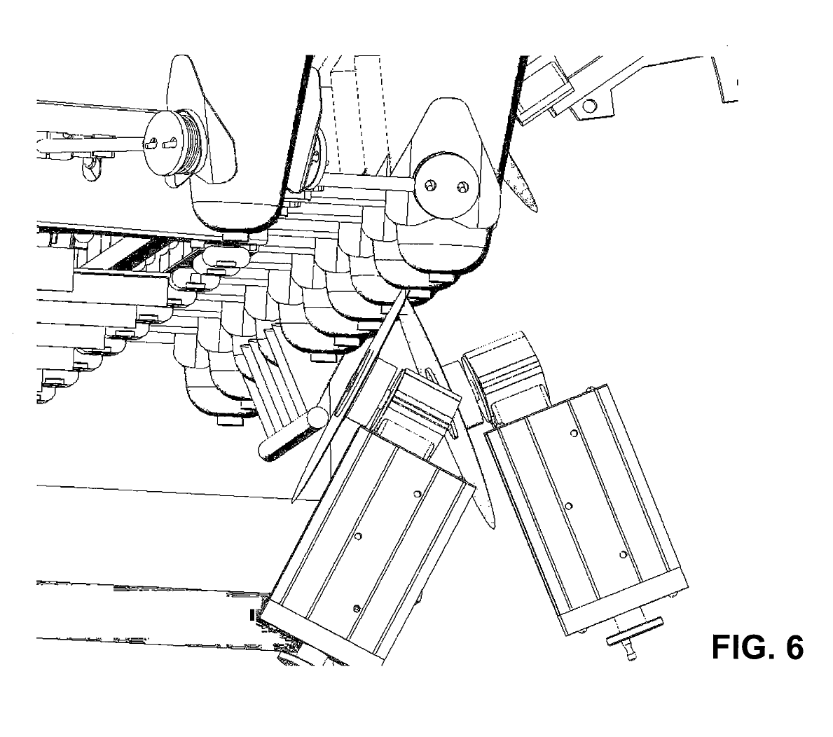

The clamped head continues along the conveyor path around the turn and enters a “blade tunnel” comprising a plurality of trimming and cutting blades 50, e.g., 5 spinning disc blades, which trim the top and upper sides, and which remove the core. In certain aspects, for example, as shown in FIGS. 5-7, two blades work together to remove the core of the plant, and three blades work together to trim the top and sides of the plant. In one aspect, two coring blades are provided to remove the core with an upside-down “V”-shaped cut as shown, e.g., in FIG. 5. FIG. 6 illustrates a close-up perspective view of the coring blades of the blade tunnel of FIG. 5. It should be appreciated that a straight, horizontal cut may be made using a single blade to remove the core of head 18, however, the inverted “V”-cut advantageously preserves more usable product in the vicinity of the core, whereas a straight cut removes an excessive amount of usable product near the core. Retaining usable product near the core is particularly advantageous as much of the weight of a produce head is concentrated near the core, and bulk product is typically purchased by the pound.

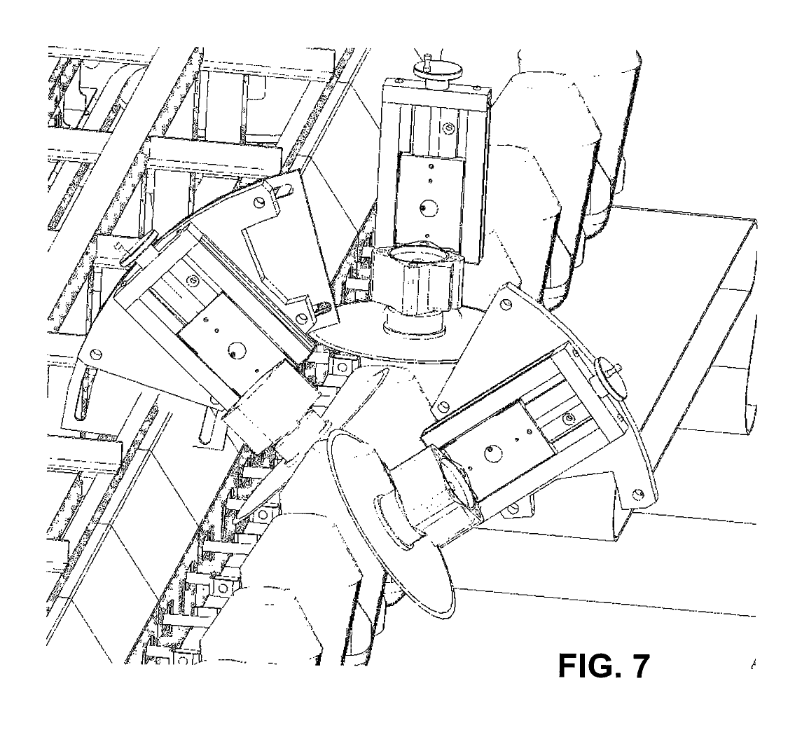

In one aspect, three trimming blades are provided to trim leaves at the top and sides of a clamped head as shown, e.g., in FIG. 5. FIG. 7 illustrates a close-up perspective view of the trimming blades of the blade tunnel of FIG. 5. In one aspect, the trimming blades, and also the coring blades, are adjustable. For example, the angle of the “V” cut made by the coring blades and the angle cut made by the side trimming blades can be adjusted manually or automatically using an angle adjustment mechanism provided on each blade. Similarly, the height of the top trimming blade may be adjustable upward or downward.

It should also be appreciated that fewer or more blades may be used. For example one or more coring blades may be used and/or a single or multiple trimming blades may be used. For example, for trimming blades, only a single top trimming blade, or only two side trimming blades may be used.

After passing through the blades 50, in one aspect, water is applied to rinse or wash the cut and trimmed head 18 in a washing zone 60 as shown, e.g., in FIG. 1. Alternatively or additionally, a wash system may be provided to wash or rinse the blades. For example, one or a plurality of spray nozzles (coupled with a water reservoir/tank via a pump) may be positioned proximal to (e.g., below, above, at the side, etc.) the blades 50 to provide a pressurized rinse treatment as heads are being trimmed and cored. In this manner, the blades may also be lubricated and cleaned by this washing system, whether by direct spray by a nozzle or by indirect run-off from a rinsed head.

After the washing zone 60, the clamp biasing mechanism is activated so that the head carrier clamps are released, allowing the cored and trimmed head to drop onto a collection conveyor 70, which in turn delivers the trimmed and cored head to a discharge conveyor 80 where the product may be retrieved and carted away in crates, totes, bins, tubes, etc.

In one aspect, one or more air pressure nozzles may be positioned along the conveyor 30 to provide a pressurized “air wash”, which helps facilitate removal of excess product such as loose leaves, left over plant material, etc. The air nozzles when appropriately positioned, may help softer, limp leaves maintain their growing orientation so that they are completely severed as they pass through the blades.

One advantage of the systems and methods of the present invention is that, although the “cutter workers” will continue to do the job as they do it now, the need for “trimmer workers” will be reduced or eliminated, thereby reducing cost. The present invention also provides the “cutter workers” with an easy target in which to place a severed Romaine head. This helps prevent those workers from being slowed down by worrying about head orientation or having to hold a head any longer than necessary. In certain aspects, the rate of empty receiver clamps passing one or more “cutter persons” exceeds the rate at which those cutters can pick and place heads when in the field. This is particularly crucial for the last cutter in a line of multiple cutters as the last cutter will typically have the fewest empty carriers available to place a severed head.

In one aspect, the conveyors 30 and 40 are mechanically connected to a drive mechanism (not shown). For example, conveyor 30 is coupled to a drive mechanism via spool elements 31.

Returning to FIG. 4, operation of an embodiment of a clamp biasing mechanism will now be described. In one embodiment, the biasing mechanism includes a cam follower wheel 27 engaging a cam track 28. As shown, clamp arms 25 are coupled with wheel 27 via a pivot mechanism as shown in more detail in FIG. 4c. As the clamp assembly 20 travels along the path of conveyor 30, wheel 27 is engaged by a ramp in the cam track 28 (e.g., bar) that operates to raise or lower the wheel and thereby open and/or close the clamp arms 25. For example, in one aspect, the wheel 27 may ride along a bar configured parallel to the path of the conveyor 30. To activate a clamp, the bar is configured to ramp up (or down) at the appropriate location, thereby raising (or lowering) wheel 27 (up or down arrow in FIG. 4a and 4b) and closing the clamp at the desired location. Similarly, as the clamp assembly 20 approaches the release point near collection conveyor 70, the bar upon which wheel 27 rides may ramp down (or up), thereby lowering (or raising) wheel 27 and opening the clamp and releasing a held head. In one aspect, as shown in FIGS. 4a and 4b, the clamping mechanism is passive to the closed position such that the mechanism must be cam activated against a biasing mechanism to the open position. It should be appreciated that the mechanism may be passive to the open position, requiring cam activation to the closed position. FIG. 4c illustrates an example of a biasing mechanism elements according to one embodiment. As can be seen, as the wheel 27 is biased downward by track 28, clamp arms 25 are biased in an outward (opening) direction (concurrent motion of various elements are shown by the arrows in FIG. 4c.; FIG. 4d shows a rear perspective view of the clamp assembly and certain clamping mechanism elements).

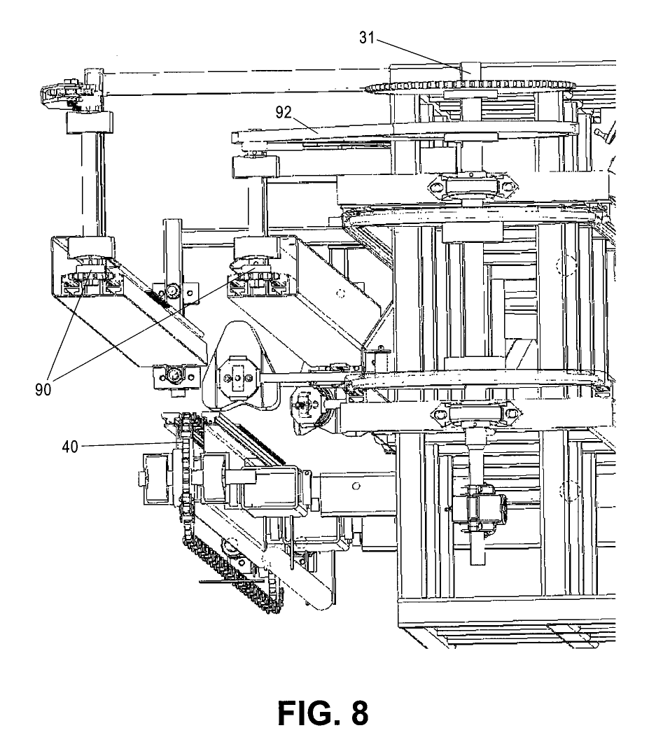

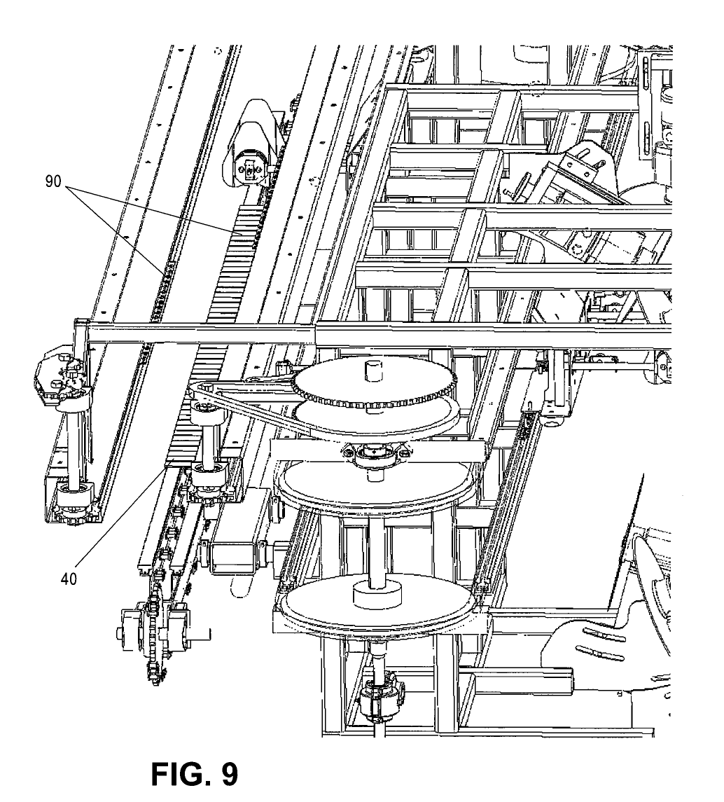

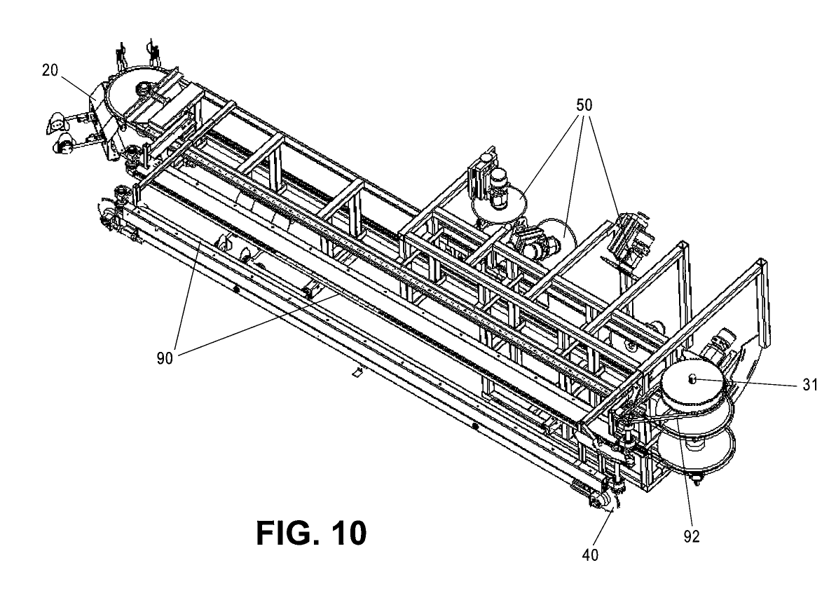

FIGS. 8-10 illustrate views of an embodiment including synchronized side conveyors 90. Side conveyors 90 are provided to constrain the orientation of a head (within open clamps) in the forward and aft directions along the support conveyor 40 until the clamps close. In one aspect, each side conveyor 90 includes a belt or other element that provides a surface to synchronously follow and constrain the motion of a head on conveyor 40. In one aspect, the synchronous belt (or other element) of each conveyor 90 is driven by a belt 92 coupled to the drive sprockets 31 of the drive mechanism that operates conveyor assembly 30. Although two conveyors 90 are shown, it should be appreciated that either or both could be used. Also, a guide rail could be used in place of a synchronized side conveyor 90 to constrain the orientation of a head, however, the use of a synchronous conveyor 90 advantageously reduces or eliminates frictional forces on the head which could disrupt the orientation or rotate the head as would be the case with stationary guide rails.

In certain aspects, the trimming apparatus of FIG. 1 is controlled by a processor or other intelligence module that executes software and/or hard-wired process instructions for controlling timing and operation of the apparatus, e.g., control of the conveyor systems, trimming and clamp systems and related systems such as wash systems, air pressure systems, etc. In certain aspects, some or all conveyors and timing functions are purely mechanically coordinated, i.e., using appropriate drive ratios to achieve synchronous conveyor speeds.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. For example, a “blade tunnel” may include blades other than circular blades, e.g., straight saw blades, wires, band saw blades, or water jet cutting systems, and any blades may be positioned in a different order or location along the path of a clamped head than is shown in the FIGS. Therefore, the scope of the appended claims should be accorded the broadest interpretation so as to encompass all such modifications and similar arrangements.

What is claimed is:

1. A lettuce trimming apparatus, comprising:
a plurality of receiver clamps coupled to a rotating conveyor system, each clamp configured to hold a head of lettuce, wherein the clamps are configured in an open state along a first portion of the conveyor system and in a closed state along a second portion of the conveyor system; and
a plurality of blades positioned in a path of the receiver clamps along the second portion of the conveyor system and configured to trim and core a lettuce head clamped in a passing receiver clamp.

2. The apparatus of claim 1, wherein the rotating conveyor system has a substantially oval shape.

3. The apparatus of claim 1, further comprising a synchronized support conveyor proximal the open receiver clamps along the first portion of the conveyor system for supporting the lettuce heads.

4. The apparatus of claim 3, wherein the support conveyor includes a plurality of receiver locations, wherein the support conveyor rotates synchronously with the rotating support belt such that each receiver clamp is positioned proximal to a receiver location for receiving the butt or stem of the lettuce head.

5. The apparatus of claim 3, wherein each receiver location includes a cup-shaped member.

6. The apparatus of claim 1, wherein the plurality of blades includes three blades configured to trim the top and sides of the lettuce head.

7. The apparatus of claim 1, wherein the plurality of blades includes two blades configured to remove the core of the lettuce head.

8. The apparatus of claim 1, further comprising a wash zone for washing trimmed and cored lettuce heads in passing receiver clamps.

9. The apparatus of claim 1, further comprising a conveyor belt in a release zone, wherein the receiver clamps are configured to open and release trimmed and cored lettuce heads proximal the conveyor belt.

10. The apparatus of claim 1, wherein the lettuce head is a Romaine lettuce head.

11. A method of automatically trimming and coring a produce head, comprising the steps of:
automatically clamping a severed produce head in known orientation in one of a plurality of clamp assemblies moving around a clamp assembly conveyor system;
transporting the clamped produce head through a cutting system comprising two or more cutting blades configured to trim and remove a core of the oriented produce head, wherein the clamped head is trimmed and cored by the cutting system; and
automatically releasing the trimmed and cored produce head proximal to a collection conveyor.

12. The method of claim 11, further including applying a water rinse to the clamped produce head.

13. The method of claim 11, further including applying a pressurized air rinse to the clamped produce head.

14. The method of claim 11, further including applying a pressurized air rinse to the clamp assembly after the trimmed and cored produce head has been released.

15. The method of claim 11, further including applying a water rinse to the clamped produce head as the clamped head is being trimmed and cored.

16. The method of claim 11, wherein the cutting system includes two cutting blades configured to remove the core with a “V”-shaped cut.

17. The method of claim 11, wherein the cutting system includes three cutting blades configured to trim the top and sides of the clamped head.

18. The method of claim 11, wherein the cutting system includes at least one cutting blade configured to remove the core.

19. The apparatus of claim 1, wherein the plurality of blades includes at least one cutting blade configured to remove the core of the lettuce head.

20. The apparatus of claim 3, further comprising at least one synchronous side conveyor configured to constrain the orientation of a supported lettuce head along the direction of motion of the synchronized support conveyor until the clamps close.
